(19) United States
(12) Patent Application Publication
(10) Pub. No.: US 2016/0016102 A1
(43) Pub. Date: Jan. 21, 2016

(54) FILTRATION APPARATUS FOR CONTAMINANT EMITTING ELECTRONICS

(71) Applicant: Charles Weldon Maddox, Norco, CA (US)

(72) Inventor: Charles Weldon Maddox, Norco, CA (US)

(21) Appl. No.: 14/796,151

(22) Filed: Jul. 10, 2015

Related U.S. Application Data
(60) Provisional application No. 62/024,637, filed on Jul. 15, 2014.

(51) Int. Cl. B01D 46/00; G06F 1/16; B01D 46/42

(52) U.S. Cl. CPC B01D 46/0023; B01D 46/42; G06F 1/16

(57) ABSTRACT

A filtration apparatus for use in storing an electronic device prevents an emission of particulates that interact with toxic materials in the electronic device from being released into a surrounding environment. The apparatus includes a housing unit to store the electronic device, an inlet assembly coupled to the housing unit, the inlet assembly having a first filter and a first fan coupled to a first aperture in the housing unit, and an outlet assembly coupled to the housing unit, the outlet assembly having a second filter and a second fan coupled to a second aperture in the housing unit. The second fan pumps air within the housing unit out the second aperture to permit the second filter to collect any harmful particulates that interacted with the toxic materials in the electronic device, thereby preventing the emission of the harmful particulates into the surrounding environment.

### RELATED APPLICATION

The application claims priority to provisional patent application U.S. Ser. No. 62/024,637 filed on Jul. 15, 2014, the entire contents of which is herein incorporated by reference.

### BACKGROUND

The embodiments herein relate generally to filtration devices for electronic devices. More specifically, the embodiments of the invention are directed to a dust free, filtration apparatus that prevents hazardous contaminants from being emitted into the atmosphere that can be harmful when inhaled or are released into an environment that needs to be sterile.

The use of electronics is a common occurrence in today's society, especially personal computers. Personal computers are used in a wide range of everyday life including, but not limited to, home use, business use and hospitals. A concern regarding the widespread use of computers is their potential to overheat and cause damage to their internal components or possibly start a fire.

To address this issue, manufacturers have used polybrominated diphenyl (PBDEs) and other flame retardants on the internal components of the computers and other electronic devices. Solving this problem has led to another issue known as toxic dust. Dust particles are sucked into the internal areas of computers and electronic devices and are expelled by their heat reducing systems, such as fans. This dust attaches and combines with particles from the PBDEs, flame retardants and other toxic materials used in these devices, such as mercury and beryllium, which are common components of motherboards. This contaminated dust is then expelled from the computer or electronic device into the surrounding environment potentially affecting human health.

A major area of concern related to this problem is sterile operating rooms in hospitals and health related facilities. While the human body has certain defenses against the toxic dust, the toxic dust can invade the body and/or blood streams of individuals who have open wounds from surgery or other exposed areas of the body. Additionally, people with compromised immune systems are more susceptible to the contaminants found in the toxic dust. This issue will continue to escalate as more and more health facilities convert from paper filing systems to digital systems.

Several existing electronic device enclosures exist as disclosed in U.S. Pat. Nos. 7,455,706 and 7,746,637. However, these enclosures comprise filter components or panels that are designed to either protect electronic equipment from undesirable contaminants that can degrade the equipment or manage air flow and heat surrounding the equipment. These devices are limited because they do not prevent the emission of toxic dust that interacts with the electronic equipment from reaching the surrounding environment.

As such, there is a need in the industry for an electronic device filtration apparatus that overcomes the limitations of the prior art, which prevents the emission of toxic dust particles into the surrounding environment.

### SUMMARY

A filtration apparatus for use in storing an electronic device is provided. The filtration apparatus is configured to prevent an emission of particulates that interact with toxic materials in the electronic device from being released into a surrounding environment. The storage apparatus comprises a housing unit configured to store the electronic device, an inlet assembly coupled to the housing unit, the inlet assembly comprising a first filter and a first fan coupled to a first aperture in the housing unit, wherein the first fan is configured to pump air from the surrounding environment into the interior of the housing unit via the first aperture to permit the first filter to prevent outside particulates from entering therein, and an outlet assembly coupled to the housing unit, the outlet assembly comprising a second filter and a second fan coupled to a second aperture in the housing unit, wherein the second fan is configured to pump air within the housing unit out the second aperture to permit the second filter to collect any harmful particulates that interacted with the toxic materials in the electronic device, thereby preventing the emission of the harmful particulates into the surrounding environment.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the filtration apparatus shown in use; and

FIG. 2 depicts a side elevation view of certain embodiments of the filtration apparatus shown in use.

### DETAILED DESCRIPTION OF CERTAIN EMBODIMENTS

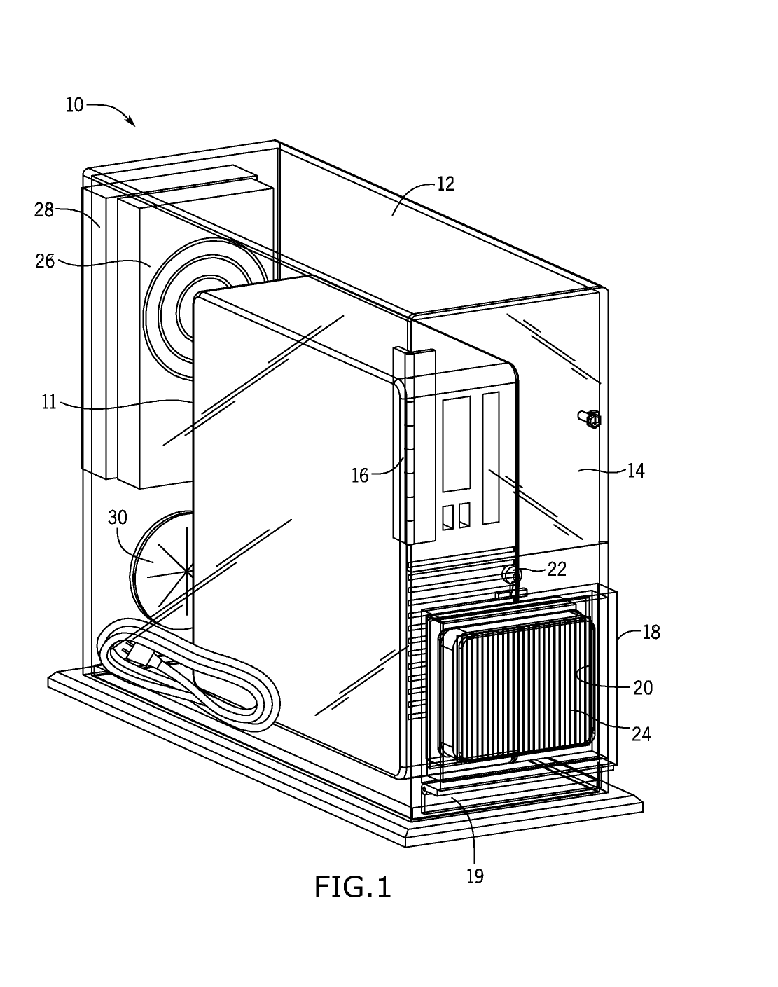

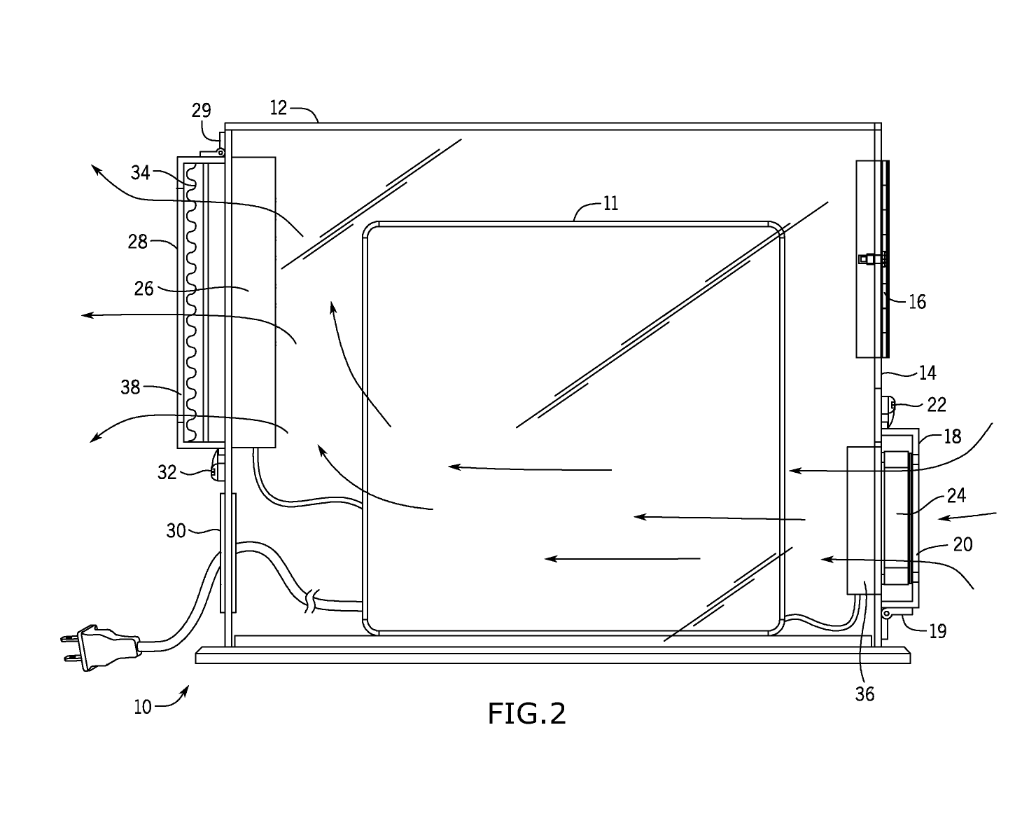

As depicted in FIGS. 1-2, filtration apparatus 10 comprises housing 12 and is configured for use with electronic device 11. In one embodiment, electronic device 11 is a central processing unit of a computer. However, it shall be appreciated that electronic device 11 may include any number and combination of central processing units, computer network servers, or the like. In addition, it shall be appreciated that electronic device 11 may be any alternative type of electronic device that may comprise toxic materials including, but not limited to, printers, scanners, networking equipment, phone systems, or the like.

Housing 12 is generally a rectangular enclosure that is sufficiently large to enclose one or more electronic devices 11. In certain embodiments, housing 12 is a cabinet that may be mounted to a wall of a room. It shall be appreciated that housing 12 may have variable shapes and dimensions, and may be made from any materials known in the field such as plastic, acrylic, aluminum, other metals, or the like. In certain embodiments, housing 12 comprises front access door 14, access seal 30, an inlet assembly and an outlet assembly.

The inlet assembly comprises inlet filter enclosure 18, inlet filter 24 and inlet filter fan 36. Inlet filter fan 36 is coupled to an opening on the front face of housing 12. Inlet filter enclosure 18 is pivotably mounted to the exterior of housing 12 proximate the front face opening by inlet filter enclosure hinge 19. Inlet filter enclosure 18 comprises aperture 20 and is configured to store inlet filter 24 therein. Inlet filter enclosure 18 may be adjusted to an open position (not shown) to expose inlet filter 24. This permits a user to easily remove, clean and/or replace inlet filter 24. Alternatively, inlet filter enclosure 18 may be adjusted to a closed position against housing 12 and locked into place by using inlet filter enclosure latch 22. As such, inlet filter enclosure latch 22 may be adjusted to an unlocked position to permit inlet filter enclosure 18 to open or a locked position to secure inlet filter enclosure 18 in the closed position.

The outlet assembly comprises outlet filter enclosure 28, outlet filter 34 and outlet filter fan 26. Outlet filter fan 26 is coupled to an opening on the rear face of housing 12. Outlet filter enclosure 28 is pivotably mounted to the exterior of housing 12 proximate the rear face opening by outlet filter enclosure hinge 29. Outlet filter enclosure 28 comprises aperture 38 and is configured to store outlet filter 34 therein. Outlet filter enclosure 28 may be adjusted to an open position (not shown) to expose outlet filter 34. This permits a user to easily remove, clean and/or replace outlet filter 34. Alternatively, outlet filter enclosure 28 may be adjusted to a closed position against housing 12 and locked into place by using outlet filter enclosure latch 32. As such, outlet filter enclosure latch 32 may be adjusted to an unlocked position to permit outlet filter enclosure 28 to open or a locked position to secure outlet filter enclosure 28 in the closed position.

Inlet filter 24 and outlet filter 34 may be any type of filter known in the field that is suitable for use in sterile environments. However, in certain embodiments, any type of high-efficiency particulate air (HEPA) filters may be used. Inlet filter fan 36 and outlet filter fan 26 may be any type of high volume airflow fans. In a preferred embodiment, outlet filter fan 26 operates at a greater airflow volume than inlet filter fan 36. This creates negative pressure within housing 12 and ensures that any air and particulates present within housing 12 are pumped towards the outlet assembly and filtered by outlet filter 34.

Front access door 14 is pivotably mounted to the front face of housing 12 by front access door hinge 16. This permits front access door 14 to open or close as needed to provide a user with access to electronic device 11. This is beneficial for a variety of reasons such as to allow the user to turn on or off electronic device 11. In certain embodiments, front access door 14 may have a locking mechanism (not shown).

In certain embodiments of the invention, access seal 30 is coupled to the rear face of housing 12. Access seal 30 comprises an outer component such as a grommet with an opening sufficiently large to permit cables, wires, plugs, or the like, associated with electronic device 11 to extend through from the interior of housing 12 to the surrounding environment. Access seal 30 may comprise a seal such as rubber flaps with slots to permit cables, wires and plugs to run through. As depicted in FIG. 2, a power plug of electronic device 11 is disposed through access seal 30 to connect with an external power socket (not shown). It shall be appreciated that inlet filter fan 36 and outlet filter fan 26 may be powered by electronic device 11 or an external power socket via connection wires.

To operate filtration apparatus 10, electronic device 11 is placed within housing 12. Electronic device 11, inlet filter fan 36 and outlet filter fan 26 are connected to a power source to enable the devices. As depicted in FIG. 2, inlet filter fan 36 draws air through aperture 20 of inlet filter enclosure 18 and into housing 12. During this process, air pumped into housing 12 is filtered by inlet filter 24 to prevent any particulates such as dust from entering and interacting with electronic device 11. Outlet filter fan 26 pumps all air within housing 12 through aperture 38 of outlet filter enclosure 28 and out to the surrounding environment. Since outlet filter fan 26 operates at a greater airflow volume than the airflow volume of inlet filter fan 36, the negative pressure created within housing 12 forces all interior air and any particulates that interacted with toxic materials of electronic device 11 to pass through outlet filter 34. As such, outlet filter 34 captures any interior particulates (toxic dust) and prevents their emission to the outside environment. This helps to maintain a sterile outside environment that is conducive to the health of individuals.

It shall be appreciated that the components of filtration apparatus 10 described in several embodiments herein may comprise any alternative known materials in the field and be of any color, size and/or dimensions. It shall be appreciated that the components of filtration apparatus 10 described herein may be manufactured and assembled using any known techniques in the field. Although the figures depict filtration apparatus 10 used with an electronic device, the apparatus may be useful in storing other contaminant emitting devices. For example, filtration apparatus 10 may be used to store plasma cutting torches or welding equipment that emit toxic gases and/or smoke.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A filtration apparatus for use in storing an electronic device, the filtration apparatus configured to prevent an emission of particulates that interact with toxic materials in the electronic device from being released into a surrounding environment, the storage apparatus comprising:
a housing unit configured to store the electronic device;
an inlet assembly coupled to the housing unit, the inlet assembly comprising a first filter and a first fan coupled to a first aperture in the housing unit, wherein the first fan is configured to pump air from the surrounding environment into the interior of the housing unit via the first aperture to permit the first filter to prevent outside particulates from entering therein; and
an outlet assembly coupled to the housing unit, the outlet assembly comprising a second filter and a second fan coupled to a second aperture in the housing unit, wherein the second fan is configured to pump air within the housing unit out the second aperture to permit the second filter to collect any harmful particulates that interacted with the toxic materials in the electronic device, thereby preventing the emission of the harmful particulates into the surrounding environment.

2. The filtration apparatus of claim 1, wherein the first fan is configured to operate at a first airflow volume and the second fan is configured to operate at a second airflow volume, wherein the second airflow volume is greater than the first airflow volume.

3. The filtration apparatus of claim 2, further comprising an inlet enclosure pivotably mounted to the housing unit and configured to store the first filter and an outlet enclosure pivotably mounted to the housing unit and configured to store the second filter.

4. The filtration apparatus of claim 3, further comprising a first latch coupled to the housing unit proximate the inlet enclosure and a second latch coupled to the housing unit proximate the outlet enclosure, wherein the first latch is configured to be adjusted to a locked position to secure the inlet enclosure to the housing unit or an unlocked position to permit the inlet enclosure to be pivotably adjusted to expose the first filter, wherein the second latch is configured to be adjusted to a locked position to secure the outlet enclosure to the housing unit or an unlocked position to permit the outlet enclosure to be pivotably adjusted to expose the second filter.

5. The filtration apparatus of claim 4, further comprising an access door pivotably mounted to the housing unit and configured to provide a user with access to the electronic device.

6. The filtration apparatus of claim 5, further comprising an access seal with an opening to permit cables associated with the electronic device to extend therethrough from the interior of the housing to the surrounding environment.
